(19) United States
(12) Patent Application Publication
(10) Pub. No.: US 2017/0214682 A1
(43) Pub. Date: Jul. 27, 2017

(54) VIRTUAL COMMUNICATION SYSTEM

(71) Applicant: Applied Electronics Corp., Tokyo (JP)

(72) Inventors: Masahiro YANO, Tokyo (JP); Mitsuhiro KANEKO, Tokyo (JP)

(21) Appl. No.: 15/500,404

(22) PCT Filed: Jul. 29, 2015
(86) PCT No.: PCT/JP2015/071529

§ 371 Date: Jan. 30, 2017

(30) Foreign Application Priority Data
Aug. 1, 2014 (JP) 2014-157422

(51) Int. Cl. H04L 29/06; G06F 9/455

(52) U.S. Cl. CPC H04L 63/083; H04L 63/0272; H04L 63/1441; G06F 9/45533; H04L 12/4641

(57) ABSTRACT

The virtual communication system 10 includes: the communication server 100 that is connectable to the terminal 12 and includes the virtual machine 108; and the authentication server 20 that performs the authentication when the terminal 12 use the communication server 100. The terminal 12, the communication server 100, and the authentication server 20 connect to one another via the intranet 40 and communicate with one another through the VPN. The terminal 12 communicate with the virtual machine 108 using the remote display protocol, and connect to the public line 46 via the virtual machine 108.

### FIELD OF THE INVENTION

The present invention relates to a virtual communication system including a communication server that connects to public lines, is connectable to terminals, and includes a virtual machine.

### BACKGROUND OF THE ART

In recent years, computer viruses have spread by web browsing. In light of this, the following systems have been employed: systems where terminals cannot connect to public lines such as the Internet and the terminals are used within an intranet. On the other hand, in some cases, the users of such systems need to collect information via a public line by browsing. In these cases, it is necessary to collect information using terminals prepared to connect to a network that is different from the intranet and is connectable to public lines. Costs for constructing such systems are high.

In a known example of those systems, the intranet is necessarily connected to external public lines via a proxy server to restrict the connection to external public lines, thereby maintaining security (see Patent Literature 1).

### REFERENCE OF THE PRIOR ART

Patent Literature 1: JP-A-2013-242929

### DISCLOSURE OF THE INVENTION

### Problems the Invention is Intended to Solve

In the system according to Patent Literature 1, however, it is difficult to maintain sufficient security even if a virus checker and the OS (Operating System) are updated under strict regulations.

The present invention has been made in light of the above problem, and it is an object of the present invention to provide a virtual communication system with high security.

### SUMMARY OF THE INVENTION

In accordance with an aspect of the present invention, a virtual communication system comprises a communication server that connects to a public line, is connectable to a terminal, and includes a virtual machine, wherein the virtual machine includes a virtual display unit that displays information acquired via the public line; the terminal includes a display unit that displays the information displayed in the virtual display unit; the terminal and the communication server connect to each other via an intranet and communicate with each other through a VPN (Virtual Private Network); the terminal communicates with the virtual machine using a remote display protocol and connects to the public line via the virtual machine, displays a virtual desktop displayed in the virtual display unit, and transmits to the communication server operation information on the basis of the virtual desktop displayed in the display unit.

In the virtual communication system, the virtual communication system further comprises an authentication server that performs authentication when the terminal uses the communication server, wherein the terminal, the communication server, and the authentication server connect to one another via the intranet and communicate with one another through the VPN; and the authentication server performs authentication of the connection from the terminal to the public line.

In the virtual communication system, the terminal transmits the operation information to the communication server via an icon in the virtual desktop displayed in the display unit; the virtual machine starts a browser in the virtual desktop displayed in the virtual display unit; the terminal displays display content of the browser in the display unit, and can acquire text information from the display content of the browser displayed in the display unit.

In the virtual communication system, the virtual communication system further comprises a firewall between the communication server and the terminal, the firewall being configured to prevent a malicious program or an executable format file downloaded through the public line from being transmitted to the terminal.

### EFFECTS OF THE INVENTION

According to the virtual communication system of the present invention, the terminals and the communication server connect to each other via the intranet and communicate with each other through a VPN, and the terminal communicates with the virtual machine using a remote display protocol and connect to public lines via the virtual machine. Thus, high security can be maintained.

According to the virtual communication system, the display content in the virtual display unit is displayed in the display unit. Thus, an infection with a malicious program such as malware including a computer virus via public lines can be prevented.

With a firewall, the deterioration in security due to malicious programs or executable format files can be prevented.

### BRIEF DESCRIPTION OF THE DRAWINGS

FIG. 1 is an explanatory view of a virtual communication system according to the embodiment of the present invention.

FIG. 2A is an explanatory view of an authentication server, and FIG. 2B is an explanatory view of a table of the authentication server.

FIG. 3 is an explanatory view of the processing procedure for the virtual communication system according to the embodiment of the present invention.

FIG. 4A is an explanatory view of a virtual desktop of the virtual machine, and FIG. 4B is an explanatory view of a virtual desktop display in a display unit of the terminal.

FIG. 5A is an explanatory view of display content in a browser of the virtual machine, and FIG. 5B is an explanatory view of virtual desktop display in the display unit of the terminal.

### DESCRIPTION OF THE PREFERRED EMBODIMENTS

<Structure of Virtual Communication System 10>

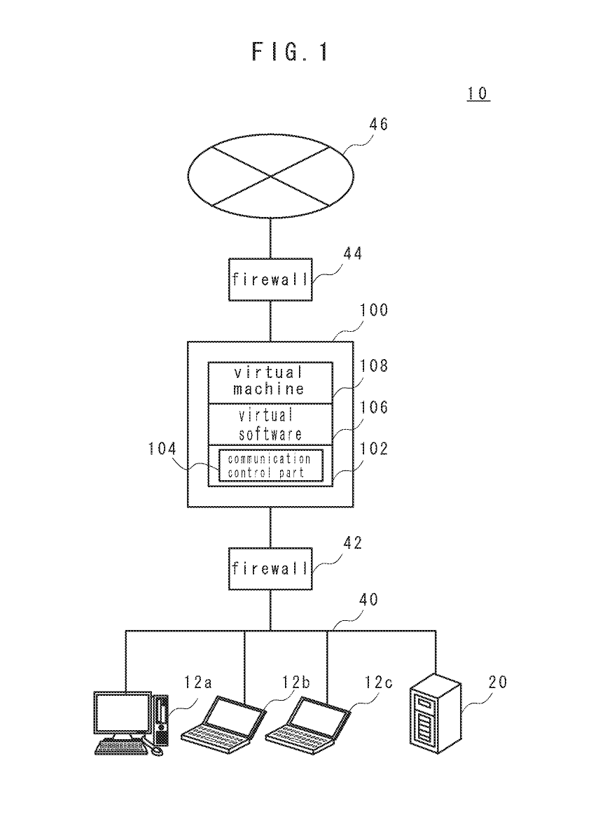

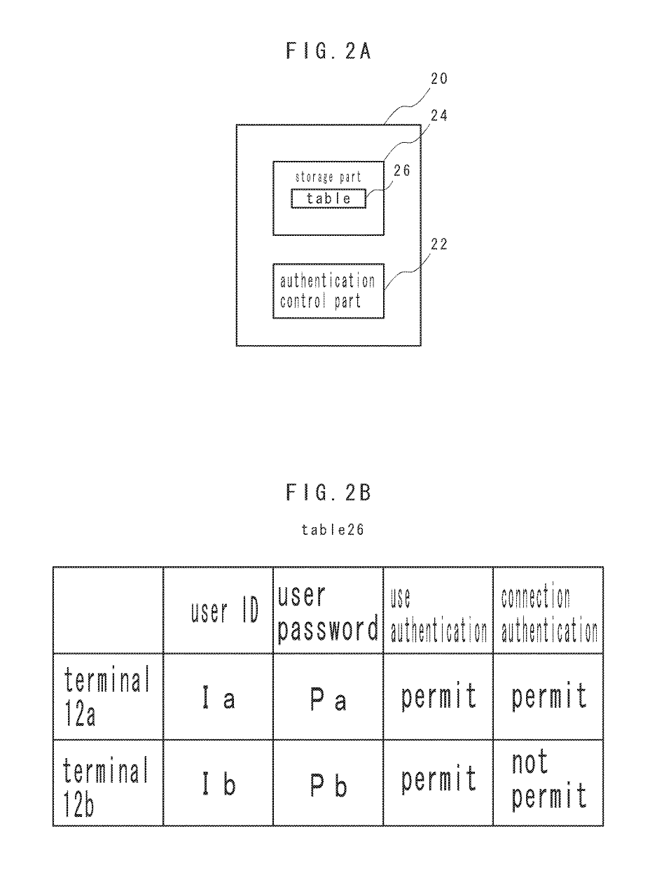

An embodiment according to the present invention will hereinafter be described with reference to drawings. FIG. 1 is an explanatory view of a virtual communication system 10 according to the embodiment of the present invention. FIG. 2A is an explanatory view of an authentication server 20, and FIG. 2B is an explanatory view of a table 26 of the authentication server 20.

The virtual communication system 10 includes terminals 12a to 12c, the authentication server 20, firewalls 42 and 44, and a communication server 100. The terminals 12a to 12c (may be collectively referred to as “terminals 12”) have the communication function.

The terminals 12, the authentication server 20, and the communication server 100 connect to one another via an intranet 40. The terminals 12, the authentication server 20, and the communication server 100 communicate with one another through a VPN (Virtual Private Network). As the VPN, for example, L2TP/IPsec (Layer 2 Tunneling Protocol/Security Architecture for Internet Protocol) can be used.

The authentication server 20 performs authentication when the terminals 12 use the communication server 100 and connect to a public line 46. The authentication server 20 includes an authentication control part 22 and a storage part 24. The storage part 24 includes the table 26.

The authentication control part 22 controls the authentication server 20 and also controls the usage of the communication server 100 by the terminals 12 and the connection from the terminals 12 to the public line 46 on the basis of the table 26.

In the table 26, for each user, the user ID, the user password, the use authentication to the communication server 100 and the connection authentication to the public line 46 are stored when the terminals 12 use the communication server 100. For example, in regard to the terminal 12a, Ia is set as the user ID, Pa is set as the user password, the use authentication to the communication server 100 and the connection authentication to the public line 46 are permitted. In regard to the terminal 12b, Ib is set as the user ID, Pb is set as the user password, the use of the communication server 100 is authorized but the connection to the public line 46 is not authorized.

The firewall 42 covers the communication between the terminals 12 and the authentication server 20, and the communication server 100. The firewall 44 covers the communication between the communication server 100 and the public line 46.

The public line 46 includes, for example, the

Internet.

The communication server 100 includes hardware 102, virtual software 106, and a virtual machine 108. The hardware 102 includes a communication control part 104 having a CPU, memory, and an auxiliary storage device (hard disk). The virtual software 106 is a control program for executing and controlling the virtual machine 108. The virtual software 106 is configured by the hypervisor, or the host OS and the virtualized layer.

<Description of operation of virtual communication system 10>

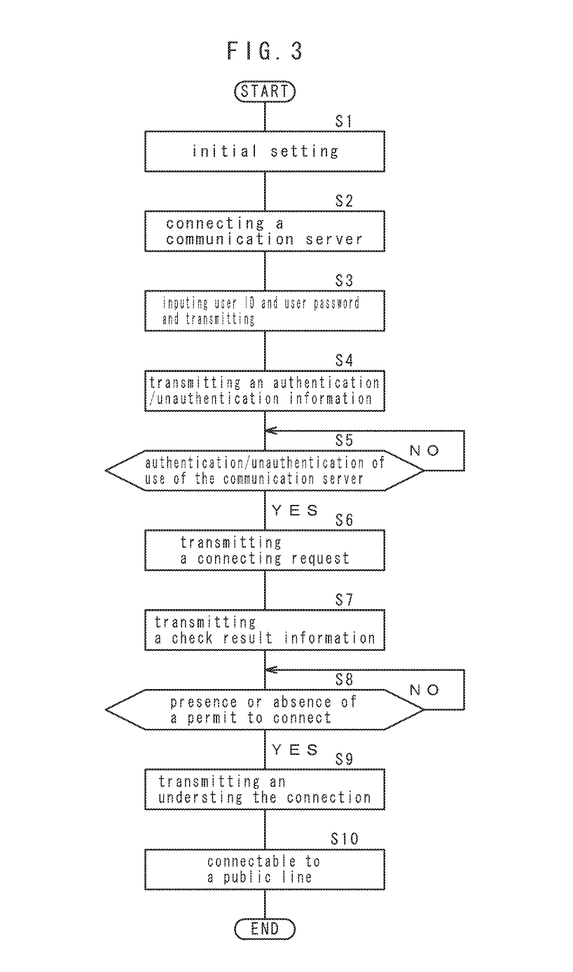

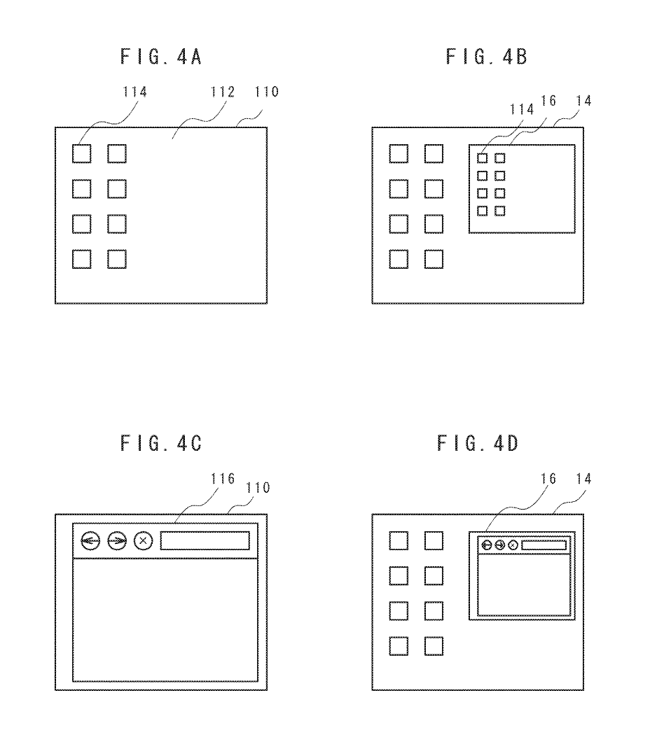

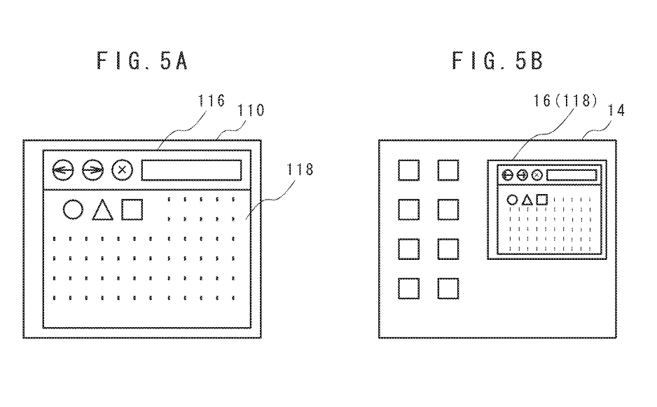

Next, the operation of the virtual communication system 10 is described with reference to FIG. 3. FIG. 3 is an explanatory view of the processing procedure for the virtual communication system 10 according to the embodiment of the present invention. FIG. 4A is an explanatory view of a virtual desktop 112 of the virtual machine 108, and FIG. 4B is an explanatory view of a virtual desktop display 16 in a display unit 14 of the terminal 12. FIG. 5A is an explanatory view of display content 118 in a browser 116 of the virtual machine 108, and FIG. 5B is an explanatory view of virtual desktop display 16 in the display unit 14 of the terminal 12. The following will describe a case in which the terminal 12a uses the communication server 100.

First, the initial setting is performed as shown in the table 26 (Step S1). Specifically, the user ID, the user password, the use authentication to the communication server 100 and the connection authentication to the public line 46 are stored in the table 26 for each user.

Next, the user connects the terminal 12a to the communication server 100 (Step S2). The communication control part 104 of the communication server 100 transmits to the terminal 12a the request for the input of the user

ID and the user password as the authentication information for using the communication server 100. The display unit 14 of the terminal 12a displays that the input is requested.

The user of the terminal 12a inputs the user ID and the user password, and the input user ID and user password are transmitted to the communication server 100. The communication control part 104 transmits the user ID and the user password to the authentication server 20 as the authentication information (Step S3).

The authentication control part 22 collates the user ID and the user password transmitted from the communication control part 104 with the user ID and the user password of the terminal 12a stored in the table 26, and transmits the authentication/unauthentication information based on the collation result to the communication server 100 (Step S4). If the user ID and the user password transmitted from the communication server 100 are Ia and Pa, respectively, the collation result indicates the match. Then, the authentication control part 22 transmits to the communication server 100 the authentication/unauthentication information representing that the use of the communication server 100 is permitted. On the other hand, if the user ID transmitted from the communication server 100 is not Ia or the user password transmitted from the communication server 100 is not Pa, the collation result indicates the mismatch. Then, the authentication control part 22 transmits to the communication server 100 the authentication/unauthentication information representing that the use of the communication server 100 is not permitted.

If the authentication/unauthentication information transmitted from the authentication control part 22 represents that the use of the communication server 100 is permitted, the communication control part 104 transmits to the terminal 12a that the use of the communication server 100 is permitted and asks the terminal 12a whether to connect to the public line 46 (Yes in Step S5). On the other hand, if the authentication/unauthentication information transmitted from the authentication control part 22 represents that the use of the communication server 100 is not permitted, the communication control part 104 requests the input of the user ID and the user password again from the terminal 12a (No in Step S5).

The display unit 14 of the terminal 12a displays that the use of the communication server 100 is permitted and asks the user whether to connect to the public line 46. Then, the user of the terminal 12a transmits to the communication server 100 that the user requests to connect to the public line 46. In addition, the communication control part 104 transmits to the authentication server 20 that the connection to the public line 46 is requested (Step S6).

When the authentication control part 22 has received the request for the connection to the public line 46 from the communication control part 104, the authentication control part 22 checks whether the connection from the terminal 12a to the public line 46 is permitted according to the table 26, and transmits the check result information to the communication server 100 (Step S7). In the table 26, the connection from the terminal 12a to the public line 46 is permitted; therefore, the authentication control part 22 transmits to the communication server 100 the check result information representing that the connection is permitted.

If the check result information transmitted from the authentication control part 22 represents that the connection is permitted, the control communication part 104 transmits to the terminal 12a that the permit to connect to the public line 46 has been ascertained (Yes in Step S8). On the other hand, if the check result information transmitted from the authentication control part 22 represents that the connection is not permitted, the communication control part 104 transmits to the terminal 12a that the permit to connect to the public line 46 has not been ascertained (No in Step S8). To allow the user of the terminal 12a to connect to the public line 46, it is necessary to set the permit to connect in the table 26.

Then, the display unit 14 of the terminal 12a displays that the permit to connect has been ascertained and the user of the terminal 12a transmits to the communication server 100 that the user has understood that the connection to the public line 46 is permitted (Step S9).

When the communication server 100 has received the user's understanding, the terminal 12a becomes connectable to the public line 46 (Step S10).

Next, the following describes the procedure of the terminal 12a for connecting to the public line 46 and browsing. First, the virtual desktop 112 displayed in the virtual display unit 110 (see FIG. 4A) is displayed in the display unit 14 of the terminal 12a as the virtual desktop display 16 (see FIG. 4B).

The user of the terminal 12a clicks an icon 114, which represents the browser corresponding to the application of the virtual desktop display 16; then, the operation information representing that the icon 114 has been clicked is transmitted to the communication server 100. Based on the operation information received by the communication control part 104, the browser 116 is started and displayed (see FIG. 4C).

The browser 116 displayed in the virtual display unit 110 is displayed as the virtual desktop display 16 in the display unit 14 (see FIG. 4D).

The user can browse by operating the browser 116 via the terminal 12a. The display content 118 displayed in the browser 116 by the user's operation (see FIG. 5A) is displayed as the virtual desktop display 16 in the display unit 14 (see FIG. 5B).

Here, the terminal 12a connects to the virtual machine 108 using the remote desktop connection based on the remote display protocol. Therefore, the information acquired via the public line 46 is limited to the content displayed in the browser 116 on the virtual desktop 112. Since the display content 118 of the browser 116 is configured by the text information and the image information, the virtual desktop display 16 in the display unit 14 is also configured by the text information and the image information, and therefore an infection with the malicious programs such as malware including a computer virus from the public line 46 can be prevented. Even if malicious programs or executable format files are downloaded directly from the public line 46, the firewall 42 can prevent the transmission thereof to the terminal 12a. In addition, since the terminal 12a exists in the intranet 40, the terminal 12a cannot connect to the public line 46 without using the communication server 100.

The remote display protocol is not limited to the particular protocol and may be any protocol that can transfer the virtual desktop 112, which is displayed in the virtual display unit 110, to the terminal 12a. Examples of the remote display protocol include the RDP (Remote Desktop Protocol), the ICA (Independent Computing Architecture) protocol, and the PCoIP (PC over IP).

Since the terminal 12b does not have the connection authentication to connect to the public line 46 in the table 26, the connection to the public line 46 is not permitted. Moreover, in regard to the terminal 12c, the user ID and the user password are not set in the table 26; therefore, the terminal 12c cannot use the communication server 100.

The virtual communication system 10 includes: the communication server 100 that is connectable to the terminal 12a and includes the virtual machine 108; and the authentication server 20 that performs the authentication when the terminals 12 use the communication server 100. The terminal 12a, the communication server 100, and the authentication server 20 connect to one another via the intranet 40 and communicate with one another through the VPN (Virtual Private Network). The communication server 100 connects to the public line 46. The authentication server 20 performs the authentication when the terminal 12a connects to the public line 46. The terminal 12a communicates with the virtual machine 108 using the remote display protocol, and connects to the public line 46 via the virtual machine 108.

In the virtual communication system 10, the terminal 12a, the communication server 100, and the authentication server 20 connect to one another via the intranet 40 and communicate with one another through the VPN. The terminal 12a communicates with the virtual machine 108 using the remote display protocol and connect to the public line 46 via the virtual machine 108. Thus, high security can be maintained.

The virtual machine 108 includes the virtual display unit 110 that displays the information acquired via the public line 46. The terminal 12 includes the display unit 14 that displays the information displayed in the virtual display unit 110.

In the virtual communication system 10, the display content 118 in the virtual display unit 110 is displayed in the display unit 14. Thus, an infection with malicious programs such as malware including a computer virus from the public line 46 can be prevented.

The firewall 42 is provided between the communication server 100 and the terminal 12a. The firewall 42 prevents malicious programs or executable format files downloaded through the public line 46 from being transmitted to the terminal 12a.

With the firewall 42, the deterioration in security due to malicious programs and executable format files can be prevented.

The present invention is not limited to the embodiment as above and can have various structures without departing from the content of the present invention.

In Step S3, the user of the terminal 12a inputs the user ID and the user password and the input user ID and user password are transmitted to the communication server 100; however, the user of the terminal 12a does not need to input the user ID and the user password as long as the user ID and the user password can be acquired. For example, when the terminal 12a has received the request for the input of the user ID and the user password, the terminal 12a may acquire the user ID and the user password stored in the digital certificate in or out of the terminal 12a instead of the user's input of the user ID and the user password, and then the terminal 12a may transmit the user ID and the user password to the communication server 100.

Steps S5 to S9 may be omitted. In this case, when the authentication control part 22 collates the user ID and the user password in the table 26 in Step S4, the authentication control part 22 checks the presence or absence of the use authentication and the connection authentication of the terminal 12a. The authentication control part 22 transmits to the communication server 100 the collation result of the user ID and the user password of the terminal 12a and the presence or absence of the use authentication and the connection authentication of the terminal 12a.

Since the terminal 12a has the use authentication and the connection authentication, the communication control part 104 transmits to the terminal 12a that the connection authentication to the public line 46 has been ascertained. The display unit 14 of the terminal 12a then displays that the connection authentication has been ascertained and thus, the terminal 12a becomes connectable to the public line 46.

### KEY TO SYMBOL

10: virtual communication system
12a,12b,12c: terminal
14: display unit
16: virtual desktop display
20: authentication server
22: authentication control part
24: storage part
26: table
40: intranet
42,44: firewall
46: public line
100: communication server
102: hardware
104: communication control part
106: virtual software
108: virtual machine
110: virtual display unit
112: virtual desktop
114: icon
116: browser
118: display content

1. A virtual communication system comprising a communication server that connects to a public line, is connectable to a terminal, and includes a virtual machine, wherein:
the virtual machine includes a virtual display unit that displays information acquired via the public line;
the terminal includes a display unit that displays the information displayed in the virtual display unit;
the terminal and the communication server connect to each other via an intranet and communicate with each other through a VPN (Virtual Private Network);
the terminal communicates with the virtual machine using a remote display protocol and connects to the public line via the virtual machine,
displays a virtual desktop displayed in the virtual display unit, and
transmits to the communication server operation information on the basis of the virtual desktop displayed in the display unit.

2. The virtual communication system according to claim 1, further comprising an authentication server that performs authentication when the terminal uses the communication server, wherein:
the terminal, the communication server, and the authentication server connect to one another via the intranet and communicate with one another through the VPN; and
the authentication server performs authentication of the connection from the terminal to the public line.

3. The virtual communication system according to claim 1, wherein:
the terminal transmits the operation information to the communication server via an icon in the virtual desktop displayed in the display unit;
the virtual machine starts a browser in the virtual desktop displayed in the virtual display unit;
the terminal displays display content of the browser in the display unit, and
can acquire text information from the display content of the browser displayed in the display unit.

4. The virtual communication system according to claim 1, further comprising a firewall between the communication server and the terminal, the firewall being configured to prevent a malicious program or an executable format file downloaded through the public line from being transmitted to the terminal.

5. The virtual communication system according to claim 2, wherein:
the terminal transmits the operation information to the communication server via an icon in the virtual desktop displayed in the display unit;
the virtual machine starts a browser in the virtual desktop displayed in the virtual display unit;
the terminal displays display content of the browser in the display unit, and
can acquire text information from the display content of the browser displayed in the display unit.

6. The virtual communication system according to claim 2, further comprising a firewall between the communication server and the terminal, the firewall being configured to prevent a malicious program or an executable format file downloaded through the public line from being transmitted to the terminal.

7. The virtual communication system according to claim 3, further comprising a firewall between the communication server and the terminal, the firewall being configured to prevent a malicious program or an executable format file downloaded through the public line from being transmitted to the terminal.

8. The virtual communication system according to claim 5, further comprising a firewall between the communication server and the terminal, the firewall being configured to prevent a malicious program or an executable format file downloaded through the public line from being transmitted to the terminal.
